(19) United States
(12) Patent Application Publication
(10) Pub. No.: US 2024/0031539 A1
(43) Pub. Date: Jan. 25, 2024

(54) CONTROL METHOD FOR DISPLAY APPARATUS, DISPLAY APPARATUS, AND NON TRANSITORY COMPUTER-READABLE STORAGE MEDIUM STORING PROGRAM

(71) Applicant: SEIKO EPSON CORPORATION, Tokyo (JP)

(72) Inventor: Shinji KUBOTA, Ina-shi (JP)

(21) Appl. No.: 18/358,093

(22) Filed: Jul. 25, 2023

(30) Foreign Application Priority Data
Jul. 25, 2022 (JP) 2022-117790

(51) Int. Cl. H04N 9/31

(52) U.S. Cl. CPC H04N 9/3194; H04N 9/3147; H04N 9/3185

(57) ABSTRACT

A control method for a first projector functioning as a display apparatus includes, when input of an image signal to the first projector is detected, displaying, by the first projector, an image based on the image signal and, when the input of the image signal is not detected, executing calibration for the first projector.

The present application is based on, and claims priority from JP Application Serial Number 2022-117790, filed Jul. 25, 2022, the disclosure of which is hereby incorporated by reference herein in its entirety.

### BACKGROUND

### 1. Technical Field

The present disclosure relates to a control method for a display apparatus, a control method for a display system, a display apparatus, and a computer-readable storage medium storing a program.

### 2. Related Art

There has been known a display apparatus installed in a conference room or the like, the display apparatus being connected to a computer or the like of a user and displaying a presentation image or the like of the user on a large screen such as a screen.

As such a display apparatus, JP-A-2006-154836 (Patent Literature 1) discloses a display apparatus that can display image signals input from various computers.

In the display apparatus disclosed in Patent Literature 1, when a change occurs in an input image signal because a computer connected to the display apparatus is switched, automatic adjustment for display setting is started.

When the automatic adjustment is started, since the display apparatus is restricted from being used until the automatic adjustment is completed, convenience of the user of the display apparatus is sometimes spoiled. For example, even when the user desires to immediately display an image even with slightly low display quality, the user needs to wait until the automatic adjustment ends.

### SUMMARY

A control method for a display apparatus according to an aspect of the present disclosure includes: when input of an image signal to the display apparatus is detected, displaying, by the display apparatus, an image based on the image signal; and, when the input of the image signal is not detected, executing calibration for the display apparatus.

A control method for a display system according to an aspect of the present disclosure includes: detecting input of a first image signal to a first display apparatus; detecting input of a second image signal to a second display apparatus; when the input of the first image signal is detected, displaying, by the first display apparatus, a first image based on the first image signal; when the input of the second image signal is detected, displaying, by the second display apparatus, a second image based on the second image signal; and, when the input of the first image signal and the input of the second image signal are not detected, executing calibration for the first display apparatus and executing calibration for the second display apparatus.

A display apparatus according to an aspect of the present disclosure includes: a first circuit configured to detect input of an image signal; a display panel configured to, when the input of the image signal is detected, display an image based on the image signal; and a second circuit configured to execute calibration when the input of the image signal is not detected.

A non-transitory computer-readable storage medium storing a program according to an aspect of the present disclosure, the program including, when input of an image signal to a display apparatus is not detected, causing a computer to execute calibration for the display apparatus.

### BRIEF DESCRIPTION OF THE DRAWINGS

FIG. 1 is a schematic diagram showing an installation example of a multi-projection system in a first embodiment.

FIG. 2 is a block diagram showing a configuration example of the multi-projection system.

FIG. 3 is a flowchart showing a procedure of automatic adjustment.

FIG. 4 is a block diagram showing a configuration example of a multi-projection system in a second embodiment.

FIG. 5 is a block diagram showing a configuration example of a projector in a third embodiment.

### DESCRIPTION OF EXEMPLARY EMBODIMENTS

Embodiments of the present disclosure are explained below with reference to the drawings.

### 1. First Embodiment

### 1.1. Configuration of a Multi-Projection System

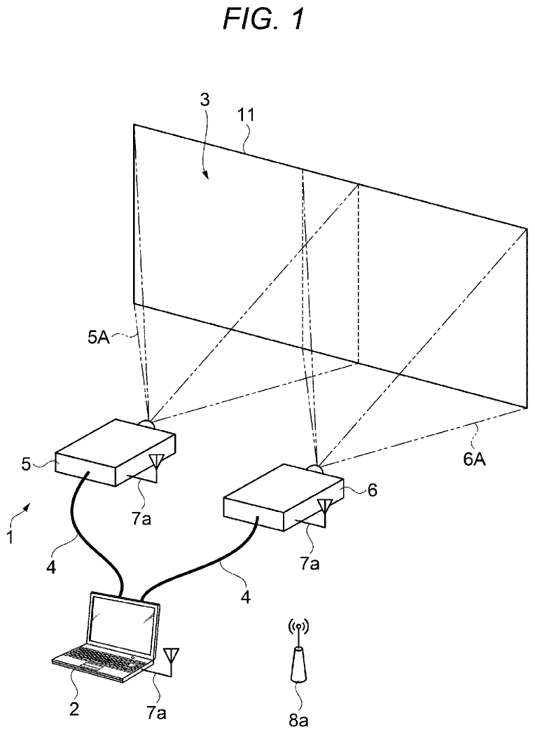

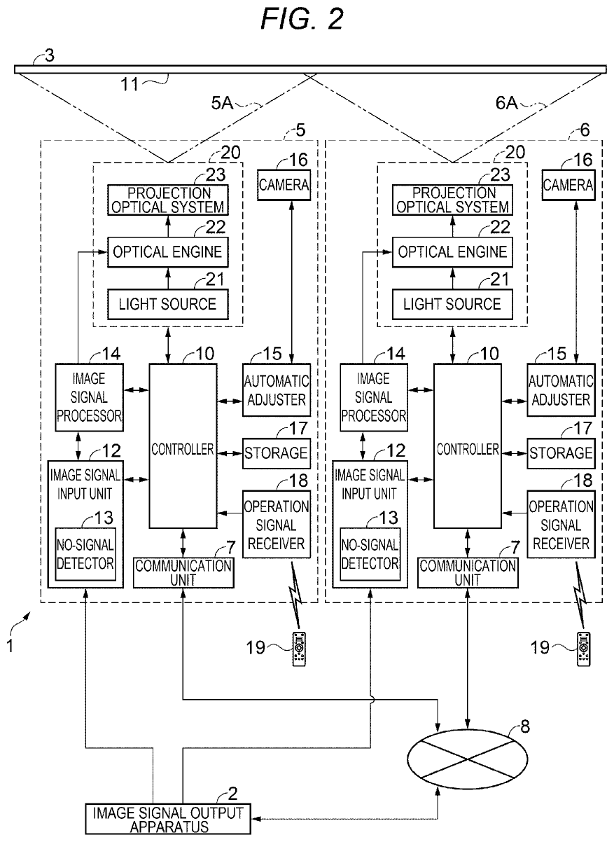

A configuration of a multi-projection system 1 functioning as a display system is explained with reference to FIGS. 1 and 2. FIG. 1 is a schematic diagram showing an installation example of a multi-projection system according to a first embodiment. FIG. 2 is a block diagram showing a configuration example of the multi-projection system according to this embodiment.

As shown in FIG. 1, the multi-projection system 1 includes a first projector 5 functioning as a display apparatus or a first display apparatus and a second projector 6 functioning as a second display apparatus. An image signal output apparatus 2, which is a computer or the like of a user, a screen 3 that displays images of the first projector 5 and the second projector 6, a transmission cable 4 such as an MIDI (Musical Instrument Digital Interface) cable or a computer cable, an antenna 7a for connection to an access point 8a of a wireless LAN (Local Area Network), and the like are connected to or disposed in the multi-projection system 1.

The image signal output apparatus 2 outputs an image signal to the first projector 5 and the second projector 6. In this embodiment, the image signal output apparatus 2 is the computer of the user. The image signal output apparatus 2 may be a smartphone, an STB (Set Top Box), a DVD (Digital Versatile Disc) player, a media server on a network connected via the access point 8a, or the like. An image signal output from the image signal output apparatus 2 may be transmitted to the first projector 5 and the second projector 6 through a wireless LAN (Local Area Network) or a wired LAN.

The multi-projection system 1 is a system that causes a projector to display a high-resolution large screen image through tiling display. The multi-projection system 1 arranges, in parallel in the horizontal direction, image light of a divided image 5A displayed by the first projector 5 and image light of a divided image 6A displayed by the second projector 6, projects the image lights onto the screen 3, and superimposes parts of the image lights on the screen 3 to form and display an entire image 11.

In this embodiment, the multi-projection system 1 configured to arrange, in parallel in the horizontal direction, and project the divided image 5A of the first projector 5 and the divided image 6A of the second projector 6 is illustrated. However, not only this, but, for example, the multi-projection system 1 may be configured to arrange, in parallel in the horizontal direction or the vertical direction, divided images projected from three or more projectors to display the entire image 11.

As shown in FIG. 2, in this embodiment, the first projector 5 and the second projector 6 have the same configuration. When automatic adjustment is performed, one of the first projector 5 and the second projector 6 is a primary projector and the other is a secondary projector. Which projector is set as the primary projector can be set in advance or a projector powered on first can be programmed to be set as the primary projector. The primary projector controls the secondary projector and controls automatic adjustment of the multi-projection system 1. The automatic adjustment is an example of the calibration.

Each of the first projector 5 and the second projector 6 includes an image signal input unit 12, a no-signal detector 13, an image signal processor 14, a projection unit 20, an automatic adjuster 15, a camera 16, a storage 17, an operation signal receiver 18, a remote controller 19, a communication unit 7, and a controller 10.

An image signal is input to the image signal input unit 12 from the image signal output apparatus 2. The image signal input unit 12 outputs the input image signal to the image signal processor 14. The image signal input unit 12 includes, for example, an input terminal for connection to various cables and an interface circuit.

The no-signal detector 13 functioning as a first circuit detects, based on a request from the controller 10, the input of the image signal to the image signal input unit 12 and outputs detection information to the controller 10. The no-signal detector 13 includes, for example, a circuit that detects the input of the image signal. The no-signal detector 13 may be configured integrally with the interface circuit included in the image signal input unit 12.

The no-signal detector 13 may be configured to, only when detecting that the image signal is input, in other words, only when not detecting the image signal is not input, output information concerning the detection to the controller 10 as detection information. Alternatively, the no-signal detector 13 may be configured to, only when detecting that the image signal is not input, in other words, only when not detecting that the image signal is input, output information concerning the detection to the controller 10 as detection information. In both the cases, the controller 10 can distinguish and determine a case in which the input of the image signal is detected and a case in which the input of the image signal is not detected.

For example, when the no-signal detector 13 is configured to, only when detecting that the image signal is not input, output information concerning the detection to the controller 10 as detection information, the detection information is output from the no-signal detector 13, whereby the controller 10 can determine that the input of the image signal is not detected. On the other hand, the detection information is not output from the no-signal detector 13, whereby the controller 10 can determine that the input of the image signal is detected.

On the other hand, when the no-signal detector 13 is configured to, only when detecting that the image signal is input, output information concerning the detection to the controller 10 as detection information, the detection information is output from the no-signal detector 13, whereby the controller 10 can determine that the input of the image signal is detected. On the other hand, the detection information is not output from the no-signal detector 13, whereby the controller 10 can determine that the input of the image signal is not detected.

The image signal processor 14 adjusts the image signal based on adjustment parameters stored in the storage 17 and outputs the adjusted image signal to the projection unit 20.

The projection unit 20 includes a light source 21 such as a laser light source, an optical engine 22 including a display element such as a liquid crystal panel or a DMD (Digital Micromirror Device), and a projection optical system 23 including a lens system. The projection unit 20 displays, on the screen 3, an image based on the image signal output from the image signal processor 14. The optical engine 22 is an example of a display panel.

The automatic adjuster 15 functioning as a second circuit performs automatic adjustment concerning image display based on an automatic adjustment program.

During the automatic adjustment, the camera 16 captures a pattern image for adjustment serving as a display video displayed on the screen 3 and outputs the pattern image to the automatic adjuster 15.

While analyzing the pattern image captured by the camera 16, the automatic adjuster 15 corrects the adjustment parameters such that the pattern image becomes a predetermined display video and, when the correction ends, stores the corrected adjustment parameters in the storage 17.

The image signal processor 14 and the automatic adjuster 15 are configured by, for example, an integrated circuit. The integrated circuit includes an LSI (Large-Scale Integration), an SOC (system on a chip), a DSP (Digital Signal Processor), an ASIC (Application Specific Integrated Circuit), a PLD (Programmable Logic Device), an FPGA (Field Programmable Gate Array), and the like. An analog circuit may be included in a part of a configuration of the integrated circuit or the integrated circuit may be combined with the controller 10.

The adjustment performed by the automatic adjuster 15 is mainly superimposition deviation adjustment, color variation adjustment, and brightness variation adjustment. Besides, frame matching adjustment and trapezoidal correction may be programmed. The order of the adjustment and content of the adjustment can be changed as appropriate by being programmed in the automatic adjustment program.

For example, the superimposition deviation adjustment can be programmed in the automatic adjustment program to be preferentially executed.

The multi-projection system 1 has an excellent advantage that a seamless large screen image can be displayed by superimposing the divided image 5A of the first projector 5 and the divided image 6A of the second projector 6. On the other hand, the multi-projection system 1 has a problem in that deviation easily occurs in the superimposition of the divided image 5A and the divided image 6A.

The superimposition deviation occurs because, for example, a person collides with the first projector 5 or the second projector 6, distortion occurs in a building because of an earthquake or unequal settlement, or distortion occurs in an installation surface of a projector because of the weight of the projector. It is known that such superimposition deviation more easily occurs and necessity of adjustment is higher than color variation and brightness variation between the divided image 5A and the divided image 6A.

A method of prioritizing the superimposition deviation adjustment may be programmed in the automatic adjustment program to, for example, execute the superimposition deviation adjustment every time and perform other adjustment at a rate of once in several times of the execution of the superimposition deviation adjustment.

Adjustment preferentially performed in the automatic adjustment is not limited to the superimposition deviation adjustment. The adjustment only has to be programmed in the automatic adjustment program such that adjustment in which adjustment deviation easily occurs can be automatically performed at an appropriate time according to an installation situation, a situation of use, and the like of the multi-projection system 1.

The adjustment may be programmed in the automatic adjustment program to perform simple adjustment such that the automatic adjustment can be completed in a short time. Consequently, it is possible to complete the automatic adjustment in a time of approximately several minutes, for example, before preparation for a conference is completed or before a presenter changes.

The simple adjustment is adjustment in which the number of pattern images to be used is approximately two or three, adjustment in which accuracy of starting adjustment or target accuracy is limited, or adjustment in which time is limited as opposed to highly accurate regular adjustment in which a large number of pattern images are used that is performed during installation. In the regular adjustment of the multi-projection system 1, while adjustment accuracy being increased little by little from provisional adjustment with low accuracy, adjustment is repeated many times to achieve highly accurate adjustment. On the other hand, in the automatic adjustment in this embodiment, since low accuracy adjustment performed during installation is unnecessary, only medium accuracy adjustment can be programmed to be performed in the automatic adjustment program. For example, in the case of the superimposition deviation adjustment, adjustment of only 1.5 pixel deviation or 1 pixel deviation can be programmed to be performed. Only high accuracy adjustment or only medium accuracy and high accuracy adjustment may be programmed to be performed.

The storage 17 is configured from memories such as a RAM (Random Access Memory) and a ROM (Read Only Memory). The storage 17 stores an OS, application programs, various data, and the like. Specifically, the storage 17 stores various control programs including the automatic adjustment program, various pattern images used in the automatic adjustment, adjustment parameters, power supply start time, an automatic adjustment history, suspension information of the automatic adjustment, a presentation image, and the like.

The adjustment parameters are stored together with adjustment history information. When the automatic adjustment is suspended, adjustment parameters before the execution of the automatic adjustment are controlled to be used by the image signal processor 14 as the latest adjustment parameters.

The communication unit 7 is connected to a network 8 such as an Intranet or the Internet. The communication unit 7 includes, for example, a terminal connected to a cable for wired communication, an antenna for wireless communication, and an interface circuit. The various control programs including the automatic adjustment program stored in the storage 17 can be always updated to the latest states by downloading an update program from a not-shown server via the network 8. Note that an image signal may be supplied through the network 8.

The operation signal receiver 18 receives an operation signal from the remote controller 19. The operation signal receiver 18 includes, for example, an infrared ray receiver that receives a signal from the remote controller 19 and a wireless communication circuit.

The controller 10 is one or more processors such as a CPU (Central Processing Unit) and controls the units based on the various control programs stored in the storage 17. A part or all of blocks including the controller 10 may be realized by hardware such as an LSI, an SOC, a DSP, an ASIC, a PLD, or an FPGA.

### 1.2. Control Method for the Multi-Projection System

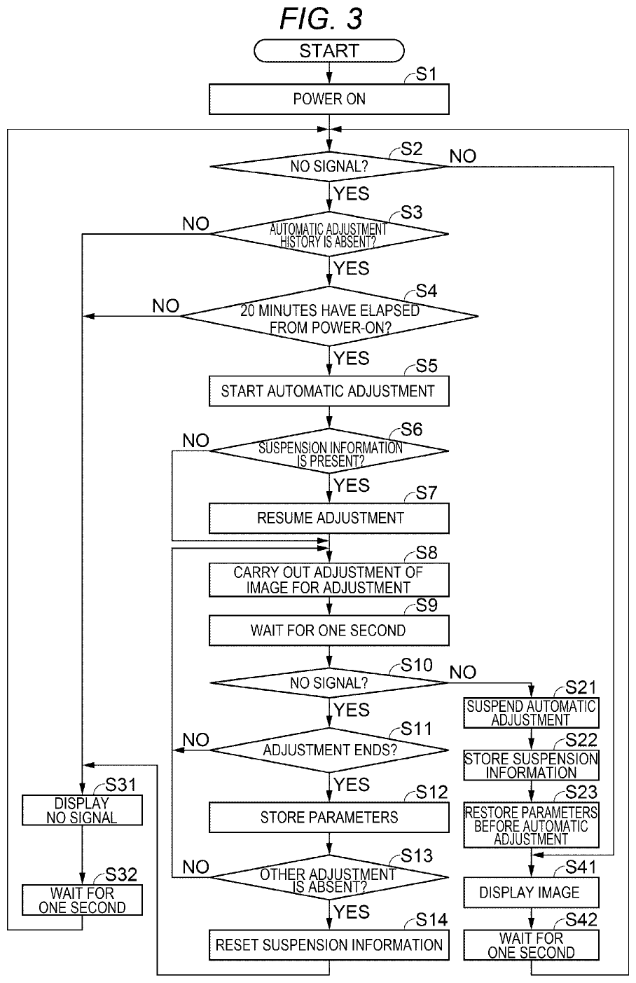

Subsequently, a control method for the multi-projection system 1 is explained with reference to FIG. 3. FIG. 3 is a flowchart showing a flow of control based on the automatic adjustment program and shows a flow of control executed by the primary projector.

In the following explanation of this embodiment, the first projector 5 is set as the primary projector and the second projector 6 is set as the secondary projector. The primary projector requests the secondary projector to transmit state information of the secondary projector including detection information of the no-signal detector 13 and controls start, suspension, end, and the like of the automatic adjustment based on state information of the entire multi-projection system 1 including the secondary projector.

In step S1, the first projector 5 and the second projector 6 are powered on. The automatic adjustment program starts simultaneously with the power-on. The automatic adjustment program resides while the first projector 5 and the second projector 6 are on. Based on the automatic adjustment program, the controller 10 stores time when the first projector 5 and the second projector 6 were powered on in the storages 17 and resets the automatic adjustment history stored in the storages 17 to “absent”.

In step S2, the controller 10 determines input of an image signal to the first projector 5 and the second projector 6.

Based on a transmission request from the controller 10 of the first projector 5, the no-signal detectors 13 of the first projector 5 and the second projector 6 transmit a detection result of presence or absence of the input of the image signal to the controller 10. The controller 10 determines the input of the image signal based on the detection result.

When the input of the image signal is detected (NO in step S2), the controller 10 leaves the automatic adjustment flow and transitions to step S41. In step S41, the first projector 5 and the second projector 6 perform image display based on the image signal. Thereafter, in step S42, after one second, the automatic adjustment flow is executed again.

On the other hand, when the input of the image signal is not detected (YES in step S2), the controller 10 transitions to step S3. In step S3, the controller 10 determines presence or absence of the automatic adjustment history.

If the input of the image signal is not detected in step S2, the controller 10 further determines whether the automatic adjustment has been performed after the power-on. This is to prevent the same adjustment from being repeatedly executed many times after the power-on.

The automatic adjustment history is stored in the storages 17. The automatic adjustment history is reset to “absent” at the time of the power-on and, thereafter, changed to “present” when the automatic adjustment is completed. When the automatic adjustment is suspended, the automatic adjustment history remains “absent”.

When the automatic adjustment history is “present” (NO in step S3), the controller 10 leaves the automatic adjustment flow and the processing transitions to step S31. In step S31, the first projector 5 and the second projector 6 perform no-signal display such as a blue screen. Thereafter, in step S32, after one second, the automatic adjustment flow is executed again.

Even when the automatic adjustment history is “present”, when a long time has elapsed from the power-on, for example, when one hour has elapsed from the power-on, thereafter, the automatic adjustment history may be programmed to be reset to “absent” in every one hour.

The determination of the automatic adjustment history may be programmed to be skipped. For example, when the automatic adjustment is affected by wind or the like because of an outdoor use or when adjustment deviation easily occurs because of disorder or the like of a projector, by skipping the determination of the automatic adjustment history, it is also possible to cope with a case in which deviation occurs after the automatic adjustment.

On the other hand, when the automatic adjustment history is “absent” (YES in step S3), the processing transitions to step S4. In step S4, the controller 10 determines whether twenty minutes have elapsed as a first period from the power-on.

When twenty minutes have not elapsed from the power-on (NO in step S4), the controller 10 leaves the automatic adjustment flow and the processing transitions to step S31. This is because, when adjustment is performed in a state in which the first projector 5 and the second projector 6 are not warmed, thereafter, deviation easily occurs and accurate adjustment cannot be performed. The first period is not limited to twenty minutes. The first period only has to be set to a desired time until states of the first projector 5 and the second projector 6 stabilize.

The determination of the elapsed time from the power-on may be programmed to be skipped. For example, when a state of the projector stabilizes in a very short time after the power-on or when an item with a small temperature drift is adjusted, for example, when the superimposition deviation adjustment is performed, the determination of the elapsed time from the power-on can be programed to be skipped. On the other hand, when an item with a large temperature drift is adjusted, for example, color variation adjustment is performed, the determination of the elapsed time from the power-on may be programmed to be performed.

On the other hand, when twenty minutes have elapsed from the power-on (YES in step S4), the processing transitions to step S5. In step S5, the controller 10 starts the automatic adjustment.

The automatic adjustment is started when the image signal is not input to the first projector 5 and the second projector 6 and the automatic adjustment history is absent and twenty minutes or more have elapsed from the first projector 5 and the second projector 6 were powered on.

According to the start of the automatic adjustment, processing of step S6 to step S14 or step S6 to step S23 explained below is executed.

According to the start of the automatic adjustment, the cameras 16 of the first projector 5 and the second projector 6 are started.

In step S6, the controller 10 determines presence or absence of suspension information of the automatic adjustment.

When the automatic adjustment is suspended, the suspension information is stored in the storages 17. For example, as first processing, a first pattern image is displayed in the first projector 5 and the second projector 6, the first pattern image is captured by the cameras 16, and the automatic adjustment is performed. After the adjustment by the first pattern image ends, while, as second processing, a second pattern image is displayed, the second pattern image is captured by the cameras 16, and the automatic adjustment is performed, when the automatic adjustment is suspended, occurrence of the suspension during the automatic adjustment by the second pattern image is stored as the suspension information.

The pattern image is a gray code pattern, a binary code pattern, a phase shift pattern, or the like. The first pattern image displayed on the first projector 5 corresponds to a first display video and the first pattern image displayed on the second projector 6 corresponds to a second display video.

When the suspension information of the automatic adjustment is absent (NO in step S6), the controller 10 skips step S7 and the processing transitions to step S8.

On the other hand, when the suspension information of the automatic adjustment is present (YES in step S6), the processing transitions to step S7. In step S7, the adjustment is resumed based on the suspension information of the automatic adjustment.

When the suspension information is stored, the suspension information is read from the storages 17 and the adjustment is resumed based on the suspension information.

When the suspension occurs during the automatic adjustment by the second pattern image as explained above, the first projector 5 and the second projector 6 resume the automatic adjustment from the second pattern image.

In step S8, a pattern image to be used in the automatic adjustment is displayed on the screen 3 from the first projector 5 and the second projector 6 and the automatic adjustment is carried out.

When the suspension information is not stored, the first pattern image is displayed based on the automatic adjustment program. When the suspension information is stored, a pattern image is displayed based on the suspension information.

In step S9, the controller 10 executes waiting for one second. The waiting time in step S9, step S32, and step S42 is not limited to one second. If the waiting time is changed to a time longer than one second, a load of the controller 10 is reduced but a response time to operation of the user increases. Therefore, the time only has to be changed as appropriate according to the performance of the CPU and a use situation of the user.

In step S10, the controller 10 determines presence or absence of the input of the image signal.

When the image signal is input to the first projector 5 and the second projector 6 (NO in step S10), the controller 10 leaves the automatic adjustment flow and the processing transitions to step S21. Consequently, when the user attempts to display an image of the user in the multi-projection system 1 during the automatic adjustment, it is possible to immediately suspend the automatic adjustment and display the image of the user.

On the other hand, when the input of the image signal is absent (YES in step S10), the processing transitions to step S11. In step S11, the controller 10 determines whether the adjustment has ended.

For example, the controller 10 determines whether the adjustment by the first pattern image has ended. When the adjustment has not ended (NO in step S11), the processing returns to step S8 and the controller 10 continues the adjustment by the first pattern image.

On the other hand, when the adjustment has ended (YES in step S11), the processing transitions to step S12. In step S12, the controller 10 stores the adjustment parameters adjusted by the automatic adjustment.

For example, when the adjustment by the first pattern image ends, the adjusted adjustment parameters are stored in the storage 17 of the first projector 5 and the storage 17 of the second projector 6 as the latest adjustment parameters. The previous adjustment parameters are stored in the storages 17 at least until all the automatic adjustments are completed.

In step S13, the controller 10 determines whether other adjustment is present.

For example, when adjustment by a second pattern image is programmed in the automatic adjustment program (NO in step S13), the processing returns to step S8 and the controller 10 executes the adjustment by the second pattern image.

On the other hand, when other adjustment is absent (YES in step S13), the processing transitions to step S14. In step S14, the controller 10 resets the suspension information stored in the storages 17.

When all the adjustments programmed in the automatic adjustment program end, the controller 10 ends the automatic adjustment and resets the suspension information stored in the storages 17. Consequently, thereafter, the first projector 5 and the second projector 6 perform image display with the adjustment parameters serving as the second parameters stored in the storages 17 in step S12.

In step S21, the controller 10 suspends the automatic adjustment. In step S10, when determining that the input of the image signal is not detected in the first projector 5 and the second projector 6, the controller 10 leaves the automatic adjustment flow and suspends the automatic adjustment.

In step S22, the controller 10 stores suspension information.

As explained above, when the automatic adjustment is suspended during the automatic adjustment by the second pattern image, occurrence of the suspension during the automatic adjustment by the second pattern image is stored in the storages 17 as the suspension information.

In step S23, the adjustment parameters before the execution of the automatic adjustment are restored. In step S12, even when new adjustment parameters are stored, when the adjustment is suspended, the previous adjustment parameters before the execution of the automatic adjustment are stored in the storages 17 of the first projector 5 and the second projector 6 as the latest adjustment parameters.

Consequently, when suspension occurs during the automatic adjustment, the first projector 5 and the second projector 6 perform image display with the previous adjustment parameters before the execution of the automatic adjustment serving as first parameters. That is, when suspension occurs during the automatic adjustment, since the adjustment parameters of the multi-projection system 1 are not changed, the image display is performed using the previous adjustment parameters serving as the first parameters. On the other hand, when the automatic adjustment is completed, image display is performed by the adjustment parameters stored anew by the automatic adjustment serving as the second parameters.

As explained above, according to this embodiment, the following effects can be obtained.

A control method for the first projector 5 functioning as a display apparatus according to an aspect of the present disclosure includes, when input of an image signal to the first projector 5 is detected, the first projector 5 displaying an image based on the image signal and, when the input of the image signal is not detected, executing calibration for the first projector 5.

Consequently, when the input of the image signal to the first projector 5 is not detected, automatic adjustment serving as the calibration is executed and, when the input of the image signal to the first projector 5 is detected, image display based on the input image signal is executed.

Therefore, it is possible to prevent convenience of a user from being spoiled and realize a control method for a display apparatus with high convenience.

Further, when the automatic adjustment is executed by scheduling, if the multi-projection system 1 is used at a scheduled date and time or the first projector 5 and the second projector 6 are off, the automatic adjustment is skipped. However, according to this embodiment, since the automatic adjustment is executed when the input of the image signal is absent, it is possible to surely perform the automatic adjustment.

The input of the image signal being detected includes absence of the input of the image signal being not detected. The input of the image signal being not detected includes absence of the input of the image signal being detected.

The control method for the first projector 5 functioning as the display apparatus according to the aspect of the present disclosure further includes, when the input of the image signal is detected during the execution of the calibration, suspending the calibration.

Consequently, when the input of the image signal is detected during the execution of the automatic adjustment, since the adjustment is suspended, it is possible to prevent convenience of the user being spoiled.

In the control method for the first projector 5 functioning as the display apparatus according to the aspect of the present disclosure, the calibration includes adjustment performed as first processing by displaying the first pattern image and adjustment performed as second processing different from the first processing by displaying the second pattern image. The control method further includes suspending the second processing when the input of the image signal is detected during execution of the second processing after execution of the first processing and resuming the second processing when the input of the image signal is stopped being detected after the second processing is suspended.

Consequently, when the automatic adjustment is suspended, thereafter, when the automatic adjustment is performed again, since the adjustment can be resumed from a suspended adjustment item, it is possible to realize a control method for a display apparatus with high convenience.

The control method for the first projector 5 functioning as the display apparatus according to the aspect of the present disclosure further includes, when the calibration is suspended, the first projector 5 displaying the image signal based on the previous adjustment parameters serving as first parameters, resuming the calibration when, after the calibration is suspended, the input of the image signal is stopped being detected during the display based on the first parameters, when the calibration is completed, storing adjustment parameters adjusted by the automatic adjustment serving as second parameters obtained by the calibration, and, after the storage of the second parameters, when the input of the image signal is detected, the first projector 5 displaying the image signal based on the second parameters.

Consequently, when the automatic adjustment is suspended, since an image is displayed by the adjustment parameters before the execution of the automatic adjustment, image display is performed by the adjustment parameters stored halfway in the adjustment, whereby it is possible to prevent a display failure from occurring. Therefore, it is possible to realize a control method for a display apparatus with high convenience.

In the control method for the first projector 5 functioning as the display apparatus according to the aspect of the present disclosure, the calibration is further executed when the input of the image signal is not detected and when twenty minutes has elapsed as a first period after the first projector 5 was powered on.

Consequently, since the automatic adjustment is controlled to be performed after the first projector 5 is warmed and a state of the first projector 5 stabilizes, it is possible to prevent, because the automatic adjustment is executed before the state of the first projector 5 stabilizes, adjustment deviation from occurring thereafter. Therefore, it is possible to realize a control method of a display apparatus with high convenience.

A control method for the multi-projection system 1 functioning as a display system according to an aspect of the present disclosure includes detecting input of a first image signal to the first projector 5 functioning as the first display apparatus, detecting input of a second image signal to the second projector 6 functioning as the second display apparatus, when the input of the first image signal is detected, the first projector 5 displaying a first image based on the first image signal, when the input of the second image signal is detected, the second projector 6 displaying a second image based on the second image signal, and, when the input of the first image signal and the input of the second image signal are not detected, executing calibration for the first projector 5 and executing calibration for the second projector 6.

Consequently, when the input of the image signal to the first projector 5 and the second projector 6 is not detected, the automatic adjustment is controlled to be executed and, when the input of the image signal to the first projector 5 and the second projector 6 is detected, image display based on the input image signal is controlled to be executed.

Therefore, it is possible to prevent convenience of a user from being spoiled and it is possible to realize a control method for a display system with high convenience.

The first projector 5 functioning as a display apparatus according to an aspect of the present disclosure includes the no-signal detector 13 functioning as a first circuit that detects input of an image signal, the projection unit 20 functioning as the display panel that, when input of an image signal is detected, displays an image based on the image signal, and the automatic adjuster 15 functioning as a second circuit that executes calibration when the input of the image signal is not detected.

Consequently, when the input of the image signal to the first projector 5 is not detected, the automatic adjustment is executed and, when the input of the image signal to the first projector 5 is detected, image display based on the input image signal is executed.

Therefore, it is possible to prevent convenience of a user from being spoiled and it is possible to realize a display apparatus with high convenience.

A program according to an aspect of the present disclosure includes, when input of an image signal to the first projector 5 functioning as a display apparatus is not detected, causing a computer to execute calibration for the first projector 5.

Consequently, when the input of the image signal to the first projector 5 is not detected, the program causes the computer to execute the calibration for the first projector 5.

Therefore, it is possible to prevent convenience of a user from being spoiled and it is possible to realize a program with high convenience.

### 2. Second Embodiment

### 2.1. Configuration of a Multi-Projection System

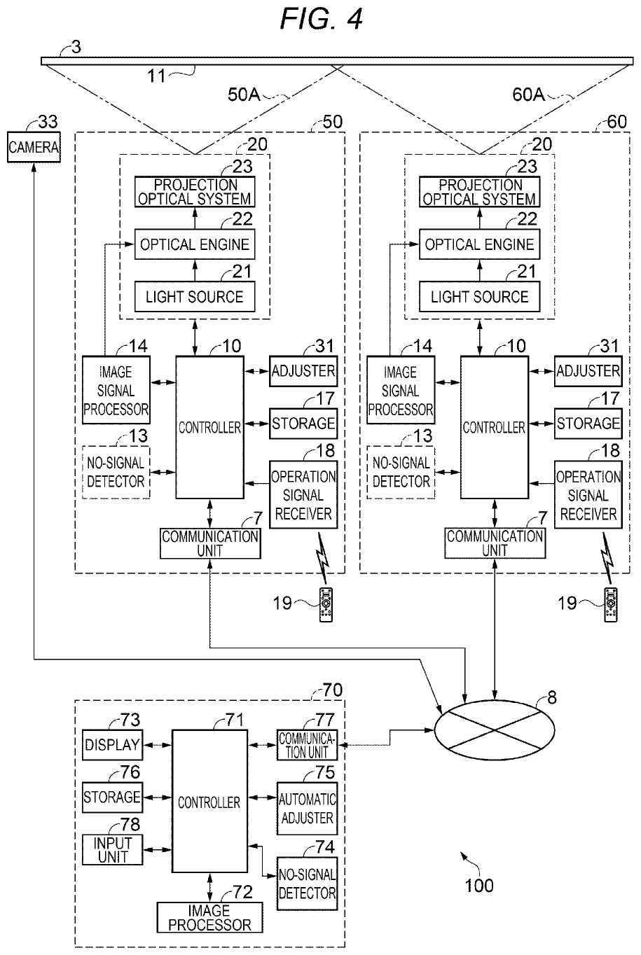

A configuration of a multi-projection system 100 functioning as a display system is explained with reference to FIG. 4. FIG. 4 is a block diagram showing a configuration example of a multi-projection system according to a second embodiment. In the following explanation, the same components and the same procedures as the components and the procedures in the first embodiment are denoted by the same reference numerals and signs and redundant explanation of the components and the procedures is omitted.

As shown in FIG. 4, the multi-projection system 100 is configured from a computer 70, a first projector 50 functioning as a display apparatus or a first display apparatus, a second projector 60 functioning as a second display apparatus, and a camera 33. The screen 3 and the network 8 are disposed in or connected to the multi-projection system 100. The computer 70 and the first projector 50, the second projector 60, and the camera 33 are connected via the network 8. Accordingly, the computer 70 does not need to be present in the same place as the first projector 50, the second projector 60, and the camera 33.

The multi-projection system 100 in this embodiment is different from the multi-projection system 1 in the first embodiment in that the computer 70 controls automatic adjustment.

The computer 70 includes a controller 71, an image processor 72, a display 73, a no-signal detector 74, an automatic adjuster 75, a storage 76, a communication unit 77, and an input unit 78.

The controller 71 is, for example, one or more processors. The communication unit 77 includes, for example, a terminal connected to a cable for wired communication, an antenna for wireless communication, and an interface circuit.

The image processor 72 generates a divided image 50A and a divided image 60A based on image information stored in the storage 76 or image information stored in a server on the network 8 and outputs the divided image 50A and the divided image 60A respectively to the first projector 50 and the second projector 60.

The no-signal detector 74 monitors presence or absence of the output of the divided image 50A and the divided image 60A to the first projector 50 and the second projector 60 and outputs detection information to the controller 71. The no-signal detector 74 includes, for example, a circuit that detects output of an image signal. The no-signal detector 74 may be configured integrally with the interface circuit included in the communication unit 77.

The automatic adjuster 75 performs automatic adjustment concerning image display based on an automatic adjustment program.

The image processor 72 and the automatic adjuster 75 is configured by, for example, an integrated circuit. The integrated circuit includes an LSI, an SOC, a DSP, an ASIC, a PLD, and an FPGA. An analog circuit may be included in a part of components of the integrated circuit or may be combined with the controller 71.

Based on a transmission request from the computer 70, during the automatic adjustment, the camera 33 captures a pattern image for adjustment displayed on the screen 3 and transmits the pattern image to the automatic adjuster 75.

While analyzing the pattern image captured by the camera 33, the automatic adjuster 75 corrects adjustment parameters such that the pattern image becomes a predetermined display video and, when the correction ends, stores the corrected adjustment parameters in the storage 76.

The storage 76 is configured from memories such as a RAM and a ROM. The storage 76 stores an OS, application programs, various data, and the like. Specifically, the storage 76 stores various control programs including the automatic adjustment program, adjustment parameters for image adjustment, and various kinds of information such as power supply start time, an automatic adjustment history, and suspension information of automatic adjustment.

The first projector 50 and the second projector 60 have the same configuration.

When the automatic adjustment is started, adjusters 31 of the first projector 50 and the second projector 60 execute adjustment based on a control signal transmitted from the computer 70.

The first projector 50 and the second projector 60 may include the no-signal detector 13. In this case, based on a transmission request of the computer 70, the no-signal detector 13 monitors presence or absence of input of an image signal and transmits a monitoring result to the computer 70.

### 2.2. Control Method for the Multi-Projection System

Subsequently, a control method for the multi-projection system 100 is explained with reference to FIG. 3. In this embodiment, the computer 70 controls the automatic adjustment. A flow of control executed by the computer 70 is substantially the same as the control executed by the primary projector in the first embodiment.

In step S1, the first projector 50 and the second projector 60 are started. The start of the first projector 50 and the second projector 60 may be controlled from the computer 70. The automatic adjustment program may be programmed to start simultaneously with the start of the first projector 50 and the second projector 60.

In step S2, it is determined whether an image signal is input to the first projector 50 and the second projector 60. The controller 71 determines presence or absence of the input of the image signal based on detection information received from the no-signal detector 74 or the no-signal detector 13.

In step S3, the controller 71 determines presence or absence of an automatic adjustment history.

When the input of the image signal is absent (YES in step S2), the controller 71 further determines whether the automatic adjustment has been performed after the first projector 50 and the second projector 60 are powered-on. The automatic adjustment history is stored in the storage 76, reset to “absent” when the first projector 50 and the second projector 60 are powered on, and, thereafter, changed to “present” when the automatic adjustment is completed.

In step S4, the controller 71 determines whether twenty minutes have elapsed from the power-on of the first projector 50 and the second projector 60.

In step S5, the controller 71 starts the automatic adjustment.

According to the start of the automatic adjustment, the computer 70 starts the camera 33 and executes processing in step S6 to step S14 and step S21 to step S23 explained below.

In step S6, the controller 71 determines presence or absence of suspension information of the automatic adjustment. The suspension information is stored in the storage 76.

In step S7, the adjustment is resumed based on the suspension information of the automatic adjustment.

When the suspension information is stored, the suspension information is read from the storage 76 and the adjustment is resumed based on the suspension information.

In step S8, a pattern image to be used in the automatic adjustment is displayed on the screen 3 and the automatic adjustment is carried out.

The adjusters 31 of the first projector 50 and the second projector 60 receive control of the computer 70 and display pattern images.

In step S12, adjustment parameters adjusted by the automatic adjustment are stored. The adjustment parameters are respectively stored in the storages 17 of the first projector 50 and the second projector 60.

In step S14, the suspension information stored in the storage 76 or the storages 17 is reset. When all adjustments programmed in the automatic adjustment program end, the controller 71 completes the automatic adjustment and resets the suspension information stored in the storage 76 or the storages 17.

In step S22, the controller 71 stores the suspension information. The controller 71 stores the suspension information in the storage 76 or the storages 17.

As explained above, according to this embodiment, the following effects can be obtained in addition to the effects of the embodiments explained above.

A control method for the first projector 50 functioning as a display apparatus according to an aspect of the present disclosure includes, when input of an image signal to the first projector 50 is detected, the first projector 50 displaying an image based on the image signal and, when the input of the image signal is not detected, the first projector 50 adjusting a pattern image serving as a display video.

Consequently, when the input of the image signal to the first projector 50 is not detected, the automatic adjustment is executed and, when the input of the image signal to the first projector 50 is detected, image display based on the input image signal is executed.

Therefore, it is possible to prevent convenience of a user from being spoiled and it is possible to realize a control method for a display apparatus with high convenience.

A control method for the multi-projection system 100 functioning as a display system according to an aspect of the present disclosure includes detecting input of a first image signal to the first projector 50 functioning as the first display apparatus, detecting input of a second image signal to the second projector 60 functioning as the second display apparatus, when the input of the first image signal is detected, the first projector 50 displaying a first image based on the first image signal, when the input of the second image signal is detected, the second projector 60 displaying a second image based on the second image signal, and, when the input of the first image signal and the input of the second image signal are not detected, the first projector 50 adjusting a pattern image serving as a first display video and the second projector 60 adjusting a pattern image serving as a second display video.

Consequently, when the input of the image signals to the first projector 50 and the second projector 60 is not detected, the automatic adjustment is controlled to be executed and, when the input of the image signals to the first projector 50 and the second projector 60 is detected, image display based on the input image signals is controlled to be executed.

Therefore, it is possible to prevent convenience of a user from being spoiled and it is possible to realize a control method for a display system with high convenience.

A program according to an aspect of the present disclosure includes, when input of an image signal to the first projector 50 functioning as a display apparatus is not detected, causing the first projector 50 to execute adjustment of a pattern image serving as a display video.

Consequently, when the input of the image signal to the first projector 50 is not detected, the program causes the first projector 50 to execute the adjustment of the display video.

Therefore, it is possible to prevent convenience of a user from being spoiled and it is possible to realize a program with high convenience.

### 3. Third Embodiment

### 3.1. Configuration of a Projector

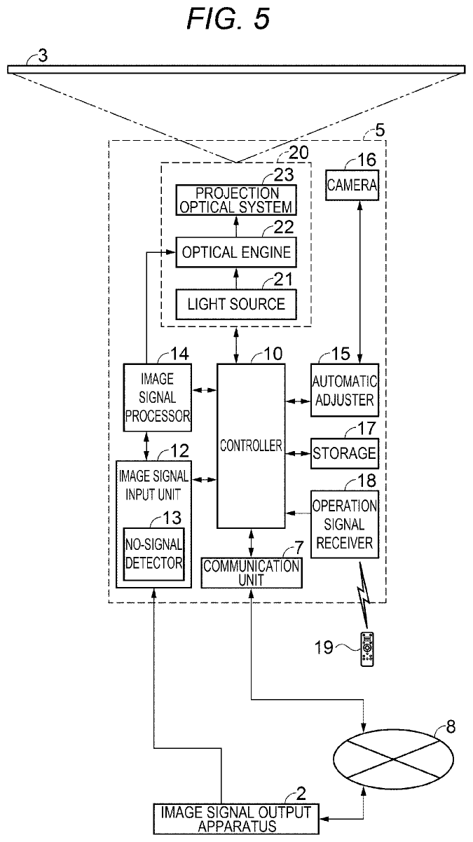

A configuration of a projector 5 functioning as a display apparatus is explained with reference to FIG. 5. FIG. 5 is a block diagram showing a configuration example of a projector according to a third embodiment. In the following explanation, the same components and the same procedures as the components and the procedures in the first embodiment are denoted by the same reference numerals and signs and redundant explanation of the components and the procedures is omitted.

As shown in FIG. 5, the projector 5 displays a large screen image on the screen 3 based on an image signal input from the image signal output apparatus 2.

The projector 5 in this embodiment is different from the multi-projection system 1 in the first embodiment in that the projector 5 displays a large screen with one projector.

The projector 5 has the same configuration as the configuration of the first projector 5 in the first embodiment. An automatic adjustment program stored in the storage 17 is programmed to operate in the same manner as the automatic adjustment program in the first embodiment except that control of a secondary projector is unnecessary and a part of adjustment content executed during automatic adjustment is different.

In this embodiment, as adjustment to be executed by the automatic adjustment program, for example, frame matching adjustment for matching a display image of the projector 5 to a frame of the screen 3 and trapezoidal correction for adjusting the display image of the projector 5 to be square can be programmed.

In the first embodiment and the second embodiment, an example is explained in which the projector is used as the display apparatus. However, a multi-display system may be configured by adopting a direct-view type display such as an FPD (Flat Panel Display) as the display apparatus. In this case, as the adjustment to be executed by the automatic adjustment program, for example, color variation adjustment and brightness variation adjustment can be programmed. A panel included in the direct-view type display such as the FPD is an example of the display panel.

In the third embodiment 3, an example is explained in which the projector is used as the display apparatus. However, a direct-view type display such as an FPD may be adopted as the display apparatus. In this case, as the adjustment to be executed by the automatic adjustment program, for example, resolution adjustment, brightness adjustment, and color tone adjustment can be programmed. A panel included in the direct-view type display such as the FPD is an example of the display panel.

The present disclosure is explained above based on the preferred embodiments. However, the present disclosure is not limited to the embodiments explained above. The components of the units of the present disclosure can be replaced with any components that exert the same functions as the functions in the embodiments explained above and any components can be added.

### SUMMARY OF THE PRESENT DISCLOSURE

A summary of the present disclosure is noted below.

### (Note 1)

A control method for a display apparatus including:
when input of an image signal to the display apparatus is detected, displaying, by the display apparatus, an image based on the image signal; and
when the input of the image signal is not detected, executing calibration for the display apparatus.

Consequently, when the input of the image signal to the display apparatus is not detected, automatic adjustment is executed and, when the input of the image signal to the display apparatus is detected, image display based on the input image signal is executed.

Therefore, it is possible to prevent convenience of a user from being spoiled and it is possible to realize a control method for a display apparatus with high convenience.

### (Note 2)

The control method for the display apparatus described in Note 1, further including, when the input of the image signal is detected during the execution of the calibration, suspending the calibration.

Consequently, when the input of the image signal is detected during the execution of the automatic adjustment, the adjustment is suspended. Therefore, it is possible to prevent convenience of the user from being spoiled.

### (Note 3)

The control method for the display apparatus described in Note 1, wherein
the calibration includes first processing and second processing different from the first processing, and
the control method further includes:
when the input of the image signal is detected during execution of the second processing after the execution of the first processing, suspending the second processing; and
when the input of the image signal is stopped being detected after the second processing is suspended, resuming the second processing.

Consequently, when the automatic adjustment is suspended, thereafter, when the automatic adjustment is performed again, the adjustment can be resumed from a suspended adjustment item. Therefore, it is possible to realize a control method for a display apparatus with high convenience.

### (Note 4)

The control method for the display apparatus described in Note 2, further including:
when the calibration is suspended, displaying, by the display apparatus, the image signal based on a first parameter;
after the calibration is suspended, when the input of the image signal is stopped being detected during the display based on the first parameter, resuming the calibration;
when the calibration is completed, storing a second parameter obtained by the calibration; and
after the storage of the second parameter, when the input of the image signal is detected, displaying, by the display apparatus, the image signal based on the second parameter.

Consequently, when the automatic adjustment is suspended, since an image is displayed by adjustment parameters before the execution of the automatic adjustment, it is possible to prevent a display failure from occurring because the image display is performed by the adjustment parameters stored halfway in the adjustment. Therefore, it is possible to realize a control method for a display apparatus with high convenience.

### (Note 5)

The control method for the display apparatus described in any one of Note 1 to Note 4, wherein the calibration is executed when the input of the image signal is not detected and when a first period elapses after the display apparatus is powered on.

Consequently, since the automatic adjustment is controlled to be performed after the display apparatus is warmed, it is possible to prevent, because the automatic adjustment is executed before the display apparatus is warmed, adjustment deviation from occurring thereafter. Therefore, it is possible to realize a control method for a display apparatus with high convenience.

### (Note 6)

A control method for a display system including:
detecting input of a first image signal to a first display apparatus;
detecting input of a second image signal to a second display apparatus;
when the input of the first image signal is detected, displaying, by the first display apparatus, a first image based on the first image signal;
when the input of the second image signal is detected, displaying, by the second display apparatus, a second image based on the second image signal; and
when the input of the first image signal and the input of the second image signal are not detected, executing calibration for the first display apparatus and executing calibration for the second display apparatus.

Consequently, when the input of the image signals to the first display apparatus and the second display apparatus is not detected, automatic adjustment is controlled to be executed and, when the input of the image signals to the first display apparatus and the second display apparatus is detected, image display based on the input image signal is controlled to be executed. Therefore, it is possible to prevent convenience of a user from being spoiled and it is possible to realize a control method for a display system with high convenience.

### (Note 7)

A display apparatus including:
a first circuit configured to detect input of an image signal;
a display panel configured to, when the input of the image signal is detected, display an image based on the image signal; and
a second circuit configured to execute calibration when the input of the image signal is not detected.

Consequently, when the input of the image signal to the display apparatus is not detected, automatic adjustment is executed and, when the input of the image signal to the display apparatus is detected, image display based on the input image signal is executed. Therefore, it is possible to prevent convenience of a user from being spoiled and it is possible to realize a display apparatus with high convenience.

### (Note 8)

A non-transitory computer-readable storage medium storing a program, the program including, when input of an image signal to a display apparatus is not detected, causing a computer to execute calibration for the display apparatus.

Consequently, when the input of the image signal to the display apparatus is not detected, the program causes the display apparatus to execute adjustment of a display video. Therefore, it is possible to prevent convenience of a user from being spoiled and it is possible to realize a non-transitory computer-readable storage medium storing a program with high convenience.

What is claimed is:

1. A control method for a display apparatus comprising:
when input of an image signal to the display apparatus is detected, displaying, by the display apparatus, an image based on the image signal; and
when the input of the image signal is not detected, executing calibration for the display apparatus.

2. The control method for the display apparatus according to claim 1, further comprising, when the input of the image signal is detected during the execution of the calibration, suspending the calibration.

3. The control method for the display apparatus according to claim 1, wherein
the calibration includes first processing and second processing different from the first processing, and
the control method further comprises:
when the input of the image signal is detected during execution of the second processing after the execution of the first processing, suspending the second processing; and
when the input of the image signal is stopped being detected after the second processing is suspended, resuming the second processing.

4. The control method for the display apparatus according to claim 2, further comprising:
when the calibration is suspended, displaying, by the display apparatus, the image signal based on a first parameter;
after the calibration is suspended, when the input of the image signal is stopped being detected during the display based on the first parameter, resuming the calibration;
when the calibration is completed, storing a second parameter obtained by the calibration; and
after the storage of the second parameter, when the input of the image signal is detected, displaying, by the display apparatus, the image signal based on the second parameter.

5. The control method for the display apparatus according to claim 1, wherein the calibration is executed when the input of the image signal is not detected and when a first period elapses after the display apparatus is powered on.

7. A display apparatus comprising:
a first circuit configured to detect input of an image signal;
a display panel configured to, when the input of the image signal is detected, display an image based on the image signal; and
a second circuit configured to execute calibration when the input of the image signal is not detected.

8. A non-transitory computer-readable storage medium storing a program, the program comprising, when input of an image signal to a display apparatus is not detected, causing a computer to execute calibration for the display apparatus.
